(19) United States
(12) Patent Application Publication
(10) Pub. No.: US 2013/0056024 A1
(43) Pub. Date: Mar. 7, 2013

(54) SUBSTRATE CLEANING METHOD AND SEMICONDUCTOR MANUFACTURING APPARATUS

(71) Applicants: Satohiko Hoshino, Yamanashi (JP); Hidefumi Matsui, Yamanashi (JP); Masaki Narushima, Yamanashi (JP)

(72) Inventors: Satohiko Hoshino, Yamanashi (JP); Hidefumi Matsui, Yamanashi (JP); Masaki Narushima, Yamanashi (JP)

(73) Assignees: IWATANI CORPORATION, Osaka-shi, Osaka (JP); TOKYO ELECTRON LIMITED, Tokyo (JP)

(21) Appl. No.: 13/583,355

(22) PCT Filed: Feb. 23, 2011
(86) PCT No.: PCT/JP2011/053892

§ 371 Date: Oct. 4, 2012

(30) Foreign Application Priority Data
Mar. 9, 2010 (JP) 2010-051735

(51) Int. Cl. B08B 7/04; B08B 7/02; B08B 5/02

(52) U.S. Cl. 134/1.3; 134/30; 134/94.1

(57) ABSTRACT

A substrate cleaning method for cleaning a substrate on which a film is formed with a pattern in a vacuum-state processing chamber includes a preprocessing step where the film formed on the substrate on which the pattern has been formed by an etching process is cleaned by using a cleaning gas; and a consecutive step including an oxidation step where residues attached on a surface of the pattern are oxidized by using an oxidizing gas and a reduction step where the oxidized residues are reduced by using a reducing gas, which are consecutively carried out posterior to the preprocessing step. The gases used in the preprocessing step and the consecutive step are clustered by ejecting the gases into the processing chamber from a gas nozzle whose internal pressure P_{S} is maintained to be higher than an internal pressure P_{O} of the processing chamber.

### FIELD OF THE INVENTION

The present invention relates to a substrate cleaning method which cleans a substrate on which a desired pattern is formed through an etching process and a semiconductor manufacturing apparatus for manufacturing a semiconductor by using the substrate cleaning method.

### BACKGROUND OF THE INVENTION

In a semiconductor manufacturing apparatus, when, during a Cu wiring process, a dual damascene structure is formed on a substrate or a desired pattern is formed on a substrate through transcription, exposure and development by using the lithographic technique, etching residues or ashing residues are attached on sidewalls and bottom walls of trenches, via holes and the like formed by film dry etching and/or resist ashing. As for a cleaning process for removing the etching residues and/or the ashing residues, the wet cleaning process for liquidly performing the cleaning by using a liquid chemical is mainly carried out.

With current demands for forming finer patterns and using a low-k film as an interlayer dielectric film, some problems have come to the fore. First, a pattern collapse occurs due to surface tension of a cleaning liquid chemical during the drying process after the substrate is cleaned by using the liquid chemical. Second, the damage to the low-k film gets worsened due to the infiltration of the liquid chemical. Specifically, such damage causes the dielectric constant of the low-k film to be raised or a pattern CD (critical dimension) to be increased.

Further, since via holes become thinner and bottoms thereof get deeper with the miniaturization of patterns, it becomes difficult to remove etching residues attached on the bottoms of the via holes. Accordingly, to uniformly clean the thinner via holes, even their bottoms, it is required to allow molecules having a high straight-moving property and a high directivity to collide with the bottoms of the via holes to thereby accelerate chemical or physical reactions on the bottoms of the via holes.

### SUMMARY OF THE INVENTION

In view of the above, the present invention provides a state-of-the-art improved substrate cleaning method and a semiconductor manufacturing apparatus using same, capable of cleaning a pattern formed on a substrate, even a bottom portion of the pattern, while maintaining the shape of the pattern.

In accordance with an aspect of the present invention, there is provided a substrate cleaning method for cleaning a substrate on which a film is formed with a pattern in a vacuum-state processing chamber, including a preprocessing step where the film formed on the substrate on which the pattern has been formed by an etching process is cleaned by using a cleaning gas; and a consecutive step including an oxidation step where residues attached on a surface of the pattern are oxidized by using an oxidizing gas and a reduction step where the oxidized residues are reduced by using a reducing gas, which are consecutively carried out posterior to the preprocessing step, wherein the gases used in the preprocessing step and the consecutive step are clustered by ejecting the gases into the processing chamber from a gas nozzle whose internal pressure P_{S} is maintained to be higher than an internal pressure P_{O} of the processing chamber.

With such configuration, the gas employed in the preprocessing step and the consecutive step is ejected from the gas nozzle into the processing chamber and clustered. The clustered gas is an aggregate of molecules the number of which ranges from several millions to several tens of millions. Since the clustered gas has molecules unified together and solidified into a lump, it has higher kinetic energy than the kinetic energy of each molecule. As a result, it is possible to accelerate the chemical reactions by allowing the clustered gas molecules to collide with the substrate, thereby cleaning the substrate more effectively.

Moreover, the clustered gas tends to move straight and has a high directivity, so that the clustered gas can reach the bottom of a thinly deeply formed via hole as well as a side surface thereof. Further, in a next step, the residues of the surface of the pattern and coppers on even the bottom of the via hole can be oxidized by the clustered oxidizing gas, and the oxidized residues and the oxidized coppers on even the bottom of the via hole can be reduced and removed. Accordingly, it is possible to clean the pattern completely to cope with the current fine processings.

In addition, the molecules of the clustered gas are diffused and scattered in all directions immediately after the clustered gas collide with the film of the substrate, and thus the respective kinetic energies of the molecules become scattered, thereby inflicting no significant damage on the film. Especially, such damage causes the dielectric constant of the low-k film to be raised or a pattern CD to be increased in the case of the low-k film. However, by using the clustered gas, it is possible to prevent the deterioration of the low-k film.

Besides, since the cleaning process is carried out by using the gaseous-phase gas instead of a chemical liquid, there is no problem that the pattern is collapsed due to the surface tension of the chemical liquid.

Furthermore, with this configuration, the oxidation step and the reduction step are consecutively carried out in the consecutive step after the cleaning step (preprocessing step) is carried out by using the clustered cleaning gas. This makes it possible to simply consecutively the oxidation step and the reduction step in the same processing space by a non-plasma method using the gas nozzle 110, thereby shortening the cleaning time and improving the throughput.

The cleaning gas may include at least one of NH₄OH, H₂O₂, HCL, H₂SO₄, HF and NH₄F or a combination thereof.

A distance d between the gas nozzle and the substrate may be set to be longer than a distance Xₘ from an outlet of the gas nozzle to a position where a shock wave is generated, which is defined in the following Eq. 1:

$$\frac{{X}_{m}}{{D}_{o}} = 0.67 \times {( \frac{{P}_{o}}{{P}_{s}} )}^{\frac{1}{2}} , \qquad Eq . 1$$

where D₀ is an inner diameter of the outlet of the gas nozzle, P_{S} is an internal pressure of the gas nozzle, and P₀ is an internal pressure of the processing chamber, and

wherein a gas used in each of the steps is clustered between the gas nozzle and the substrate and collides with the substrate by using the generated shock wave.

The internal pressure P_{S} of the gas nozzle may be equal to or greater than about 0.4 MPa, and the internal pressure P_{O} of the processing chamber may be equal to or smaller than about 1.5 Pa.

The internal pressure P_{S} of the gas nozzle may be equal to or smaller than about 0.9 MPa.

The substrate cleaning method may be used to clean a pattern when a wiring is formed on a substrate or to clean a resist after exposure.

In accordance with another aspect of the present invention, there is provided a semiconductor manufacturing apparatus for cleaning a film, formed on a substrate, on which a pattern has been formed in a vacuum-state processing chamber, including a gas nozzle whose internal pressure “P_{S}” is maintained to be higher than an internal pressure “P_{O}” of the processing chamber, wherein the apparatus performs a plurality of steps including a preprocessing step where a cleaning gas is clustered by ejecting the cleaning gas from the gas nozzle into the processing chamber; and a consecutive step including an oxidation step where an oxidizing gas is clustered by ejecting the oxidizing gas from the gas nozzle into the processing chamber to oxidize residues attached on a surface of the pattern by using the oxidizing gas and a reduction step where the oxidized residues are reduced by using a reducing gas, which are consecutively carried out posterior to the preprocessing step.

In accordance with still another aspect of the present invention, there is provided a semiconductor manufacturing apparatus for cleaning a film, formed on a substrate, on which a pattern has been formed in a vacuum-state processing chamber, including a gas nozzle whose internal pressure P_{S} is maintained to be higher than an internal pressure P_{O} of the processing chamber, wherein the apparatus performs a plurality of steps including a preprocessing step where a cleaning gas is clustered by ejecting the cleaning gas from the gas nozzle into the processing chamber, the cleaning gas including at least one of NH₄OH, H₂O₂, HCL, H₂SO₄, HF and NH₄F or a combination thereof; an oxidation step where an oxidizing gas is clustered by ejecting the oxidizing gas from the gas nozzle into the processing chamber to oxidize residues attached on a surface of the pattern by using the oxidizing gas posterior to the preprocessing step; and a reduction step where the oxidized residues are reduced by using a reducing gas.

As described above, in accordance with the aspects of the present invention, it is possible to clean a pattern formed on a substrate and even a bottom portion of the pattern while maintaining the shape of the pattern.

### BRIEF DESCRIPTION OF THE DRAWINGS

FIG. 1 is a longitudinal cross sectional view showing a schematic structure of a cluster apparatus in accordance with an embodiment of the present invention;

FIG. 2A explains a damage to a substrate when one molecule collides with the substrate, and FIG. 2B explains a damage to a substrate when clustered molecules collide with the substrate;

FIGS. 3A to 3F show a process for forming a dual damascene structure;

FIG. 4 shows a substrate cleaning method in accordance with the present embodiment; and

FIG. 5 shows a distance from an outlet of a gas nozzle to a shock wave in accordance with a modification of the embodiment.

### DETAILED DESCRIPTION OF THE EMBODIMENTS

An embodiment of the present invention will now be described with reference to the accompanying drawings which form a part hereof. Further, in the following description and drawings, components having substantially the same configuration and function are denoted by like reference characters, and thus redundant description thereof will be omitted herein.

(Configuration of Cluster Apparatus)

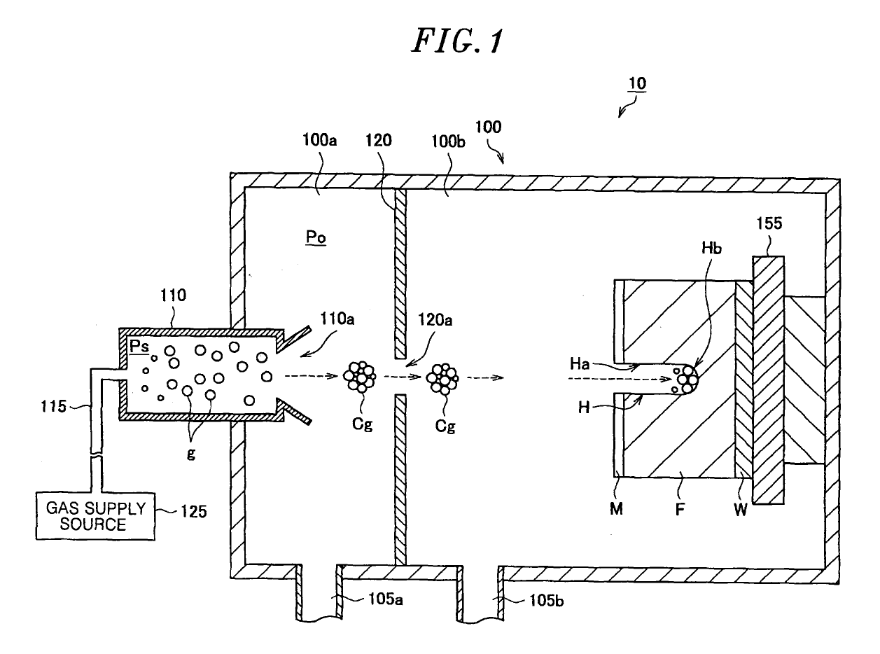

First, a schematic configuration of a cluster apparatus 10 in accordance with an embodiment of the present invention will be described with reference to FIG. 1. The cluster apparatus 10 includes a vacuum processing chamber 100 for airtightly accommodating a wafer W. The processing chamber 100 is divided by a barrier 120 into two chambers, i.e., a gas supply space 100a and a processing space 100b. Exhaust ports 105a and 105b are respectively formed at bottom walls of the gas supply space 100a and the processing space 100b to evacuate the respective spaces, and exhaust pumps (not shown) are respectively connected to the exhaust ports 105a and 105b.

A gas nozzle 110 is provided in a sidewall of the gas supply space 100a. The gas nozzle 110 is positioned in such a way as to be opened toward a target object, so that a gas ejected from the gas nozzle 110 has a directivity. A gas supply source 125 is provided at an upstream of the gas nozzle 110 via a gas supply line 115. The gas supply source 125 is provided outside the processing chamber 100 to separately store therein, e.g., a cleaning gas, an oxidizing gas and a reducing gas. A valve body (not shown) is provided in the gas supply line 115, and kinds of gases to be supplied from the gas supply line 115 to the gas nozzle 110 are switched by controlling the opening and closing of the valve body.

A supplied gas is ejected from the gas nozzle 110 and clustered. This mechanism is described as follows. The gas nozzle 110 is set such that an internal pressure P_{S} thereof ranges from about 0.4 MPa to 0.9 MPa. The processing chamber 100 is exhausted to a vacuum level such that an internal pressure P_{O} thereof is maintained to be equal to or smaller than about 1.5 Pa. As such, the gas is ejected to the processing chamber 100 from the gas nozzle 110 whose internal pressure P_{S} is maintained to be higher than the internal pressure P_{O} of the processing chamber 100.

When a gas “g” having a high reactivity is ejected from the higher-pressure gas nozzle 110 to the lower-pressure processing chamber 100, the pressure difference therebetween causes the temperature of the gas g to be quickly decreased, so that molecules of the gas g are unified together and solidified into a lump. In this way, the gas g ejected from the gas nozzle 110 to the processing chamber 100 is clustered. The clustered gas (hereinafter, referred to as “gas clusters Cg”) is an aggregate of relatively weakly bonded molecules the number of which ranges from several millions to several tens of millions.

As described above, the gas clusters Cg have directivities, but some of the gas clusters Cg do not fly straight. If these non-straight flying gas clusters collide with the wafer W, the etching or cleaning process may be carried out in unexpected directions. For that reason, the barrier 120 is provided between the gas nozzle 110 and the wafer W to prevent the non-straight flying gas clusters Cg from colliding with the wafer W. The barrier 120 has a hole 120a, so that the gas clusters Cg are introduced into the processing space 100b through the hole 120a.

In the processing space 100b, a holding member 155 is provided to hold the wafer W. The holding member 155 serves to hold the wafer W in such a way that the gas clusters Cg collide with the surface of the wafer W perpendicularly. A moving member (not shown) for moving the holding member 155 is provided to the holding member 155. The holding member 155 is moved by the moving member to have the gas clusters Cg to be uniformly supplied to an overall surface of the wafer W from the direction that is perpendicular to the surface of the wafer W.

With this configuration, it is possible to realize a good etching shape and/or a high cleaning precision. This is because etching or cleaning reactions take place only at portions where heat energies are produced due to the collisions of the gas clusters Cg thereto. The gas clusters Cg are not involved in the etching or cleaning reactions at portions where no heat energy is produced.

A mask “M”, a layer “F” provided below the mask M, and a hole “H” formed in the layer F are shown in FIG. 1. The gas clusters Cg having a directivity do not collide with a sidewall “Ha” of the deeply formed hole H, and thus no heat energy is produced at the sidewall Ha. Accordingly, the sidewall Ha of the hole H is not generally etched or cleaned. On the other hand, the gas clusters Cg collide with a bottom portion “Hb” of the deeply formed hole H, thereby etching or cleaning the bottom portion Hb. Therefore, in accordance with the present embodiment, it is possible to form a thin and deep hole having a good shape while improving the cleaning precision.

With the above configuration, it is also possible to realize a process that inflicts no electrical damage on the wafer W. In a conventional process, a reactive gas is ionized by a plasma. The thus-ionized gas has an electric energy, and thus the ionized gas may electrically damage the wafer W. However, in the cluster apparatus 10 of the present embodiment, the gas clusters Cg are not ionized. Accordingly, during the etching process, it is possible to execute the process without causing electrical damage to the wafer W.

Further, since the gas clusters Cg are not ionized in the above structure, the cluster apparatus is not required to be equipped with a plasma source. Accordingly, the cluster apparatus becomes simplified, thereby making the maintenance easy, lowering manufacturing cost and having an appropriate structure for the mass production.

[Collision of Clustered Molecules]

Next, a collision state of the clustered gas will be described with reference to FIG. 1. As described above, the gas shown in FIG. 1 is ejected from the gas nozzle 110 into the processing chamber 100 and clustered. The clustered gas (gas clusters Cg) is an aggregate of molecules ranging in number from several millions to several tens of millions. Since the clustered gas has molecules unified together and solidified into a lump, one lump of clustered molecules has higher kinetic energy than the kinetic energy of each molecule. Higher kinetic energies of the gas clusters are converted to heat energies, thereby accelerating chemical reactions. As a result, it is possible to accelerate the chemical reactions by using the higher energies produced by allowing the clustered gas molecules to collide with the wafer W, thereby cleaning the wafer W more effectively.

In addition, the clustered gas tends to move straight and has a high directivity, so that the clustered gas can reach the bottom of a thinly deeply formed via hole of, e.g., 5 μm as well as a side surface thereof, the via hole being formed in the layer F on the wafer W. Accordingly, it is possible to reliably clean the via hole, even the bottom thereof. Further, since the cleaning process is carried out by using the gaseous-phase gas instead of a chemical liquid, there is no problem that the pattern is collapsed due to the surface tension of the chemical liquid.

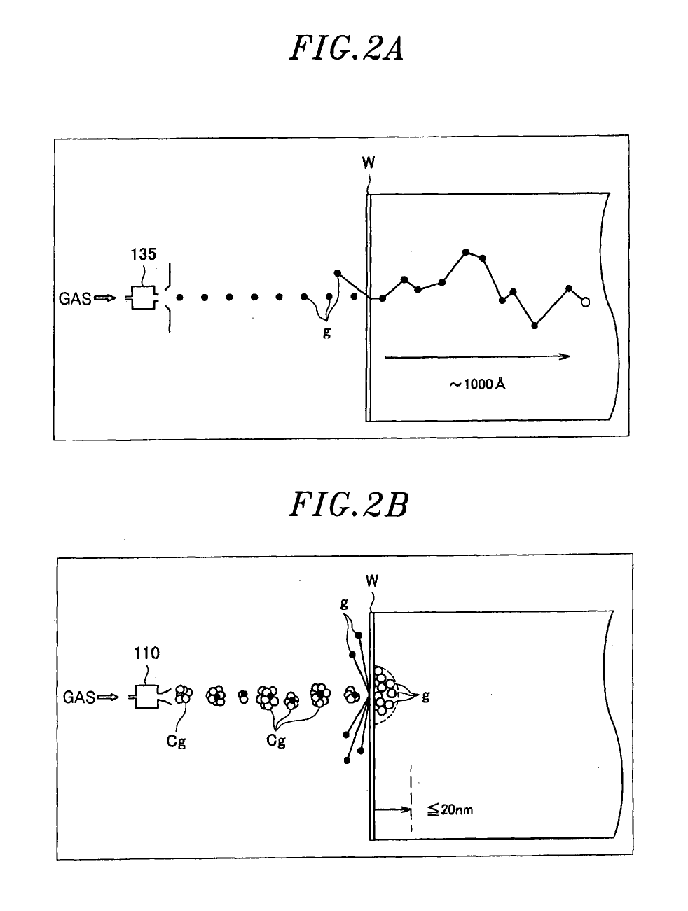

Further, the molecules of the clustered gas are diffused and scattered in all directions immediately after the clustered gas collides with the layer F of the wafer W, and thus the kinetic energies of the respective clustered gas molecules become scattered, thereby inflicting no significant damage on the layer F. This will be described with reference to FIGS. 2A and 2B. FIG. 2A shows the damage to the wafer W when one molecule collides with the wafer W, and FIG. 2B shows the damage to the wafer W when clustered molecules collide with the wafer W.

As shown in FIG. 2A, in a plasma source 135, a plasma containing reactive ions is generated. The reactive ions are not clustered, and thus they are not aggregates of molecules. Accordingly, when one molecule of the reactive ions collides with the wafer W, the energy is low. However, the wafer W, even a deep portion thereof, is affected by the damage caused by the collision.

On the other hand, as shown in 2B, a gas which is not converted to a plasma is ejected from the gas nozzle 110 and converted to gas clusters Cg. When the gas clusters Cg collide with the wafer W, the energy is high. Since, however, the molecules of the gas cluster are scattered in all directions immediately after the gas cluster collides with a film of the wafer W, it is seen that the damage to the wafer W is decreased. Especially the damage to the low-k film caused by the collision can be lowered. Accordingly, it is possible to prevent such damage from causing the dielectric constant of the low-k film to be raised or a pattern CD (critical dimension) to be increased.

(Substrate Cleaning Method Using Gas Clusters Cg)

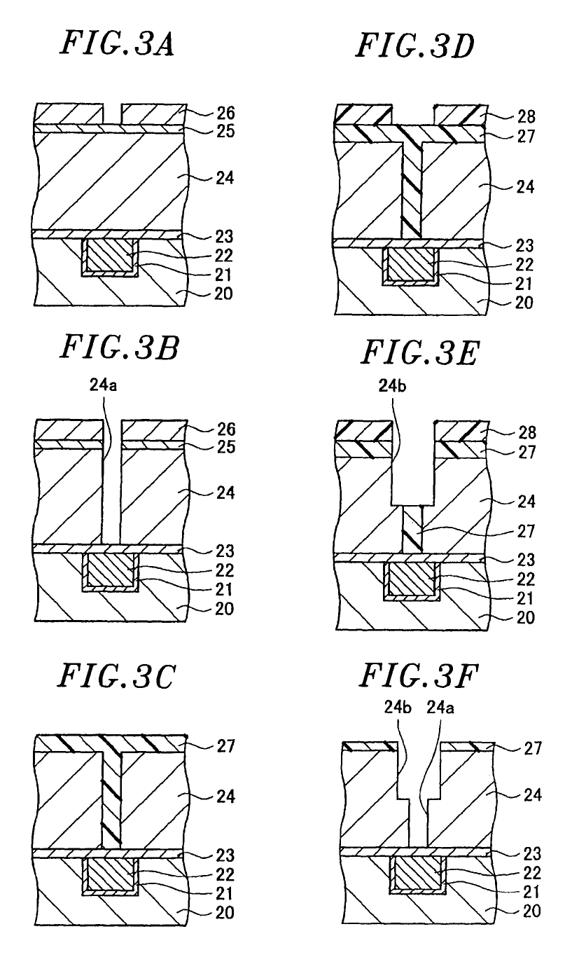

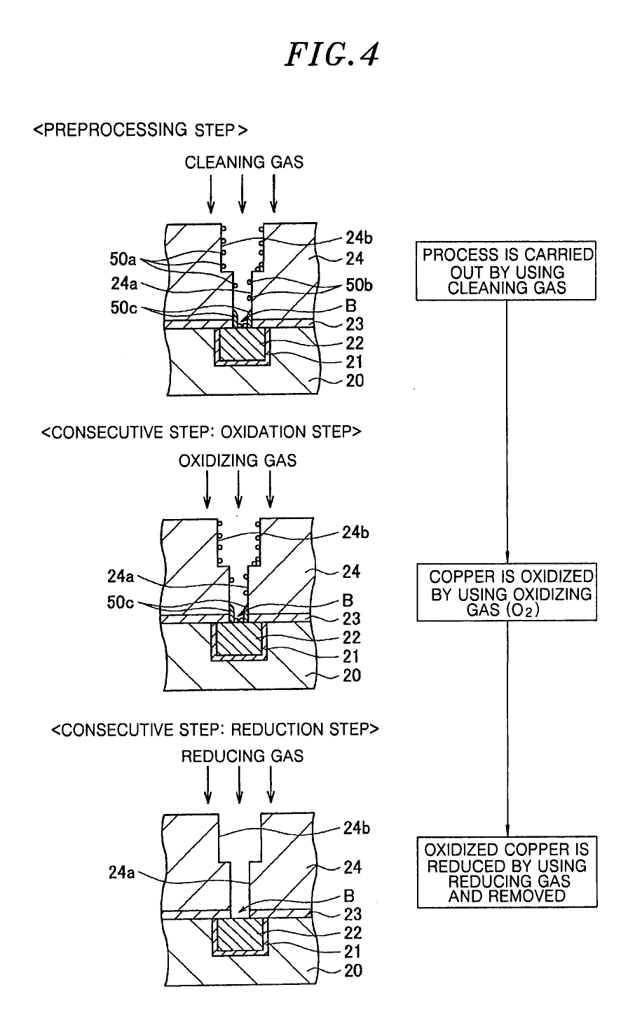

Next, a substrate cleaning method using gas clusters Cg in accordance with the present embodiment will be described. FIGS. 3A to 3F show an example of a method of forming a multilayer interconnection by dual damascene, and FIG. 4 shows a method of cleaning the wafer W in accordance with the present embodiment.

Generally, a multilayer interconnection circuit is formed on the wafer W by single or duel damascene using the photolithographic technique in the manufacturing process of a semiconductor device. In a step shown in FIG. 3A, a bottom anti-reflective coating (BARC) film 25 is formed on a low-k film 24 serving as an upper interlayer dielectric film formed on the wafer W. Then, a resist film 26 is formed on the BARC film 25. The resist film 26 is exposed in a predetermined pattern and developed to thereby form a circuit pattern thereon. Here, below the low-k film 24, a low-k film 20 serving as a lower interlayer dielectric film, a barrier metal layer 21, a Cu wiring layer and a stopper film 23 have been formed.

In a step shown in FIG. 3B, an etching process is performed on a surface of the wafer W that has been subjected to the above processings, to thereby form a via hole 24a on the low-k film 24. In a step shown in FIG. 3C, the BARC film 25 and the resist film 26 are removed by, e.g., a liquid chemical process or an ashing process. Thereafter, a sacrificial film 27 is formed on a surface of the low-k film 24 having the via hole 24a. At this time, the via hole 24a is buried in the sacrificial film 27.

In a step shown in FIG. 3D, a resist film 28 is formed on a surface of the sacrificial film 27, and the resist film 28 is exposed in a predetermined pattern and developed to thereby form a circuit pattern thereon. For a predetermined time period, an etching process is performed on a surface of the wafer W that has been subject to the above processings to thereby form a trench 24b that is wider than an upper portion of the via hole 24a as shown in FIG. 3E. Finally, as shown in FIG. 3F, a groove wiring structure including the via hole 24a and the trench 24b is formed on the low-k film 24 by removing the resist film 28 and the sacrificial film 27 by the ashing process.

In such steps, as shown in an upper part (preprocessing step) of FIG. 4, etching residues 50a are attached and left on sidewalls of the trench 24b and the via hole 24a and a bottom wall of the via hole 24a by carrying out the etching process on the via hole 24a and the trench 24b. Moreover, ashing residues 50b are attached and left on the sidewalls of the trench 24b and the via hole 24a and bottom wall of the via hole 24a by carrying out the ashing process on the resist film 27. Furthermore, coppers 50c scattered from the Cu wiring layer 22 are attached on the bottom of the via hole 24a during the pattern formation. All of the etching residues 50a, the ashing residues 50b and the coppers 50c scattered from the Cu wiring layer 22 are residues left on the pattern surface.

In accordance with the substrate cleaning method of the present embodiment, it is possible to completely remove such residues. Hereinafter, the substrate cleaning method of the present embodiment will be described.

(Preprocessing Step)

In the preprocessing step shown in FIG. 4, the wafer W on which a pattern has been formed by the etching process is cleaned by using a cleaning gas. An example of the cleaning gas may include at least one of NH₄OH, H₂O₂, HCL, H₂SO₄, HF, and NH₄F or a combination thereof. As such, a gas of a cleaning chemical liquid such as a NH₄OH liquid or the like having a high reactivity is used to clean a pattern.

The gas nozzle 110 is provided to face the via hole 24a and the trench 24b. In this state, if the cleaning gas is ejected from the gas nozzle 110, the cleaning gas is converted into gas clusters in the processing chamber 100. Such each of the gas clusters tends to move straight and has a directivity, and thus the gas clusters reach not only the sidewalls of the trench 24b and the via hole 24a but also a bottom “B” of the via hole 24a to thereby make chemical reactions with the etching residues 50a, the ashing residues 50b and the coppers 50c on the bottom B.

In this step, the cleaning gas having a high reactivity is clustered. Accordingly, it is possible to allow the clustered cleaning gas to reach the bottom B of the pattern and accelerate the chemical reaction while processing the low-k films 20 and 24 with less damage.

(Consecutive Step: Oxidation Step)

After the preprocessing step, a consecutive step including an oxidation step and a reduction step is carried out. Specifically, both of the oxidizing step and the reducing step are consecutively carried out in the same processing space without performing a transfer step between the steps.

In the oxidation step, as shown in “consecutive step: oxidizing step” of FIG. 4, the etching residues 50a and the ashing residues 50b on the pattern surface and the coppers 50c on the bottom B of the via hole 24a are oxidized by an oxidizing gas, e.g., O₂ gas.

Similarly, in this step, the oxidizing gas is clustered. Accordingly, it is possible to allow the clustered gas to reach the bottom B of the pattern and accelerate the oxidation reaction while processing the low-k films 20 and 24 with less damage.

(Consecutive step: Reduction Step)

In the reducing step, as shown in “consecutive step: reduction step” of FIG. 4, the residues 50a and 50b and the coppers 50c oxidized in the oxidation step are reduced by a reducing gas, e.g., HCOOH gas. In this step, copper formate is produced by reducing the oxidized copper by the reducing gas. The copper formate is exhausted from the processing chamber 100 since it is volatile. Accordingly, it is possible to remove the scattered coppers 50c from the Cu wiring layer 22. Similarly, oxides of the etching and ashing residues are converted to volatile substances by the reduction reaction and removed.

Similarly, in this step, the reducing gas is clustered. Accordingly, it is possible to allow the clustered gas to reach the bottom B of the pattern and accelerate the reduction reaction while processing the low-k films 20 and 24 while inflicting less damage.

Further, with this configuration, the oxidation step and the reduction step are consecutively carried out in the consecutive step after the cleaning step (preprocessing step) is carried out by using the clustered cleaning gas. This makes it possible to simply consecutively the oxidation step and the reduction step in the same processing space by a non-plasma method using the gas nozzle 110, thereby shortening the cleaning time and improving the throughput.

As described above, in accordance with the cleaning method of the present embodiment, gaseous-phase gas clusters are used instead of a liquid-phase cleaning chemical liquid. Accordingly, it is possible to prevent the pattern collapse that occurred when the cleaning chemical liquid was used. Further, by using gas clusters, each cluster having a high kinetic energy, a high straight-moving property and a high directivity, it is possible to precisely quickly clean the bottom B of the thinly deeply formed pattern. In addition, since the gas clusters Cg are weakly bonded, the gas clusters Cg inflict less damage on the low-k films 20 and 24 when colliding therewith.

(Modification)

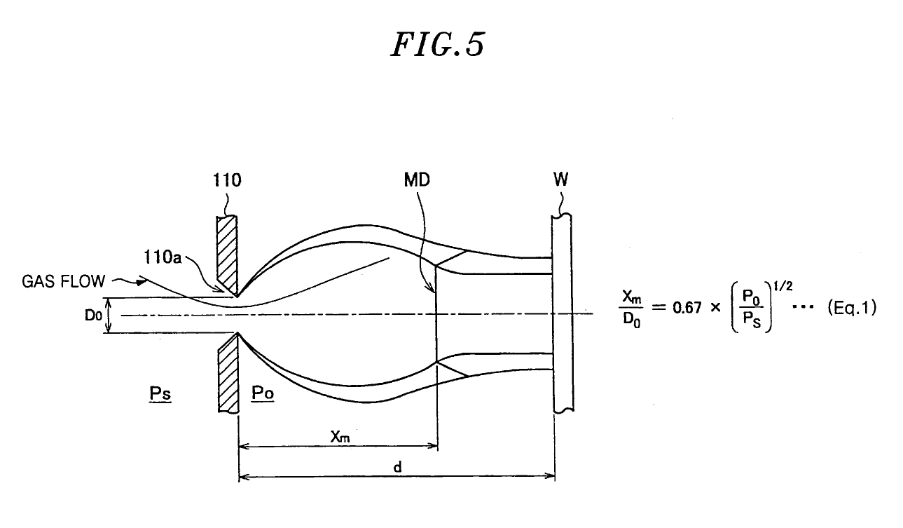

Finally, a cleaning method in accordance with a modification of the present embodiment will be described. FIG. 5 shows a distance from the nozzle outlet 110 to a shock wave. Based on ISSN0452-2982 National Aerospace Laboratory's materials (TM-741), “Flow visualization and structural analysis of free jets by LIF method” (Shoichi TSUDA, NATIONAL AEROSPACE LABORATORY 1999, 7), a distance “Xₘ” from an outlet 110a of the gas nozzle 110 to a position of a shock wave (mach disc (MD)), an inner diameter “D_{O}” of the outlet 110a serving as a throat portion of the gas nozzle 110, an internal pressure “P_{S}” of the gas nozzle 110 and an internal pressure “P_{O}” of the processing chamber 100 into which a gas is introduced have a relationship represented by the following Eq. 1.

$$\frac{{X}_{m}}{{D}_{o}} = 0.67 \times {( \frac{{P}_{o}}{{P}_{s}} )}^{\frac{1}{2}} \qquad Eq . 1$$

At this time, a distance “d” from the outlet 110a of the gas nozzle 110 to the wafer W is preferably set to be greater than the distance Xₘ to a position of the shock wave (MD) generated by a gas flow caused from the outlet 110a of the gas nozzle 110, defined in Eq. 1.

Similarly, in the modification, a gas employed in each of the above steps is clustered between the gas nozzle 110 and the wafer W and collides more strongly with the wafer W by using the energy of the shock wave (MD). Accordingly, it is possible to further accelerate the chemical reaction, thereby cleaning the via hole without inflicting any damage on the films. Especially, it is possible to completely clean even the oxidized copper attached on the bottom B of the via hole.

In the substrate cleaning method of the above embodiment, since operations of the units are related to one another, the operations can be substituted as a series of operations and a series of processings in consideration of their relationships. Accordingly, the embodiment of the substrate cleaning method can be applied to an embodiment of a semiconductor manufacturing apparatus for cleaning a substrate.

Accordingly, it is possible to realize the embodiment of the semiconductor manufacturing apparatus for cleaning a substrate on which a pattern has been formed in a vacuum-state processing chamber, the apparatus including a gas nozzle whose internal pressure P_{S} is maintained to be higher than the internal pressure P_{O} of the processing chamber. In the embodiment, the semiconductor manufacturing apparatus performs a plurality of steps including the preprocessing step and the consecutive step having the oxidation step and the reduction step. In the preprocessing step, a desired cleaning gas is clustered by ejecting the cleaning gas from the gas nozzle into the processing chamber, and a film formed on the substrate on which the pattern has been formed after an etching process is cleaned by the thus-clustered cleaning gas. Posterior to the preprocessing step, in the oxidation step, a desired oxidizing gas is clustered by ejecting the desired oxidizing gas from the gas nozzle into the processing chamber, and residues attached on a surface of the pattern are oxidized by the thus-clustered oxidizing gas. In the reduction step, the oxidized residues are reduced by a reducing gas.

The oxidation step and the reduction step of the present embodiment may be non-consecutively carried out. In this case, it is possible to realize another embodiment of the semiconductor manufacturing apparatus for cleaning a substrate on which a pattern has been formed in a vacuum-state processing chamber, the apparatus including a gas nozzle whose internal pressure P_{S} is maintained to be higher than the internal pressure P_{O} of the processing chamber. In this embodiment, the semiconductor manufacturing apparatus performs a plurality of steps including the preprocessing step, the oxidation step and the reduction step. In the preprocessing step, a desired cleaning gas is clustered by ejecting the desired cleaning gas from the gas nozzle into the processing chamber, and a film formed on the substrate is cleaned by the thus-clustered cleaning gas. An example of the cleaning gas includes at least one of NH₄OH, H₂O₂, HCL, H₂SO₄, HF and NH₄F or a combination thereof. Posterior to the preprocessing step, in the oxidation step, a desired oxidizing gas is clustered by ejecting the desired oxidizing gas from the gas nozzle into the oxidizing gas, and residues attached on a surface of the pattern are oxidized by the thus-clustered oxidizing gas. In the reduction step, the oxidized residues are reduced by a reducing gas.

While the invention has been shown and described with respect to the embodiments, it will be understood by those skilled in the art that various changes and modifications may be made without departing from the scope of the invention as defined in the following claims.

or example, in the above embodiments, the substrate cleaning method is used to clean a pattern on the bottom of the via hole and the like of the dual damascene structure, but it is not limited thereto. For example, when a desired pattern is formed on a substrate through transcription, exposure and development by using the lithographic technique, the substrate cleaning method may be employed to clean a resist and the like after the exposure.

The substrate used in the embodiments of the present invention may be a semiconductor wafer or a substrate to be used for a flat panel display (FPD).

The cluster apparatus of the present embodiments may further include an ionizer and an accelerator. In this case, the clustered gas is supplied from the gas nozzle and ionized by the ionizer, and is then accelerated by the accelerator to be perpendicularly supplied to the surface of a wafer held by the holding member 155. This apparatus is called “gas cluster ion beam (GLIB) equipment”.

What is claimed is:

1. A substrate cleaning method for cleaning a substrate on which a film is formed with a pattern in a vacuum-state processing chamber, the method comprising:
a preprocessing step where the film formed on the substrate on which the pattern has been formed by an etching process is cleaned by using a cleaning gas; and
a consecutive step including an oxidation step where residues attached on a surface of the pattern are oxidized by using an oxidizing gas and a reduction step where the oxidized residues are reduced by using a reducing gas, which are consecutively carried out posterior to the preprocessing step,
wherein the gases used in the preprocessing step and the consecutive step are clustered by ejecting the gases into the processing chamber from a gas nozzle whose internal pressure P_{S} is maintained to be higher than an internal pressure P_{O} of the processing chamber.

2. The method of claim 1, wherein the cleaning gas includes at least one of NH₄OH, H₂O₂, HCL, H₂SO₄, HF and NH₄F or a combination thereof.

3. The method of claim 1, wherein a distance d between the gas nozzle and the substrate is set to be longer than a distance Xₘ from an outlet of the gas nozzle to a position where a shock wave is generated, which is defined in the following Eq. 1:
$$\frac{{X}_{m}}{{D}_{o}} = 0.67 \times {( \frac{{P}_{o}}{{P}_{s}} )}^{\frac{1}{2}} , \qquad Eq . 1$$
where D₀ is an inner diameter of the outlet of the gas nozzle, P_{S} is an internal pressure of the gas nozzle, and P₀ is an internal pressure of the processing chamber, and
wherein a gas used in each of the steps is clustered between the gas nozzle and the substrate and collides with the substrate by using the generated shock wave.

4. The method of claim 1, wherein the internal pressure P_{S} of the gas nozzle is equal to or greater than about 0.4 MPa, and the internal pressure P_{O} of the processing chamber is equal to or smaller than about 1.5 Pa.

5. The method of claim 1, wherein the internal pressure P_{S} of the gas nozzle is equal to or smaller than about 0.9 MPa.

6. The method of claim 1, wherein the substrate cleaning method is used to clean a pattern when a wiring is formed on a substrate or to clean a resist after exposure.

7. A semiconductor manufacturing apparatus for cleaning a film, formed on a substrate, on which a pattern has been formed in a vacuum-state processing chamber, the apparatus comprising:
a gas nozzle whose internal pressure “P_{S}” is maintained to be higher than an internal pressure “P_{O}” of the processing chamber,
wherein the apparatus performs a plurality of steps including a preprocessing step where a cleaning gas is clustered by ejecting the cleaning gas from the gas nozzle into the processing chamber; and
a consecutive step including an oxidation step where an oxidizing gas is clustered by ejecting the oxidizing gas from the gas nozzle into the processing chamber to oxidize residues attached on a surface of the pattern by using the oxidizing gas and a reduction step where the oxidized residues are reduced by using a reducing gas, which are consecutively carried out posterior to the preprocessing step.

8. A semiconductor manufacturing apparatus for cleaning a film, formed on a substrate, on which a pattern has been formed in a vacuum-state processing chamber, the apparatus comprising:
a gas nozzle whose internal pressure P_{S} is maintained to be higher than an internal pressure P_{O} of the processing chamber,
wherein the apparatus performs a plurality of steps including a preprocessing step where a cleaning gas is clustered by ejecting the cleaning gas from the gas nozzle into the processing chamber, the cleaning gas including at least one of NH₄OH, H₂O₂, HCL, H₂SO₄, HF and NH₄F or a combination thereof;
an oxidation step where an oxidizing gas is clustered by ejecting the oxidizing gas from the gas nozzle into the processing chamber to oxidize residues attached on a surface of the pattern by using the oxidizing gas posterior to the preprocessing step; and
a reduction step where the oxidized residues are reduced by using a reducing gas.
